(19) United States
(12) Patent Application Publication
(10) Pub. No.: US 2026/0366855 A1
(43) Pub. Date: Nov. 19, 2026

(54) System and Method for Swept-Angle Interferometry

(71) Applicant: Carnegie Mellon University, Pittsburgh, PA (US)

(72) Inventors: Alankar Kotwal, Houston, TX (US); Ioannis Gkioulekas, Pittsburgh, PA (US)

(21) Appl. No.: 19/485,336

(22) PCT Filed: May 17, 2024
(86) PCT No.: PCT/US2024/029827

§ 371 Date: Nov. 18, 2025

Related U.S. Application Data
(60) Provisional application No. 63/467,338, filed on May 18, 2023.

(51) Int. Cl. G01B 9/02001; G01B 9/02017; G01B 11/22

(52) U.S. Cl. CPC G01B 9/02007; G01B 9/02019; G01B 11/22; G01B 2290/65

(57) ABSTRACT

Provided are systems and methods for swept-angle interferometry. A system includes a light source configured to emit at least one beam having at least two wavelengths, a beam steering device configured to steer the at least one beam across at least one axis of motion, a lens arranged in an optical path between the beam steering device and a target of the at least one beam, the lens having a focal plane, and a relay lens arranged in the optical path between the beam steering device and the lens.

### CROSS REFERENCE TO RELATED APPLICATIONS

This application is the Unites States national phase of International Application No. PCT/US24/29827, filed May 17, 2024, and claims the benefit of U.S. Provisional Patent Application No. 63/467,338, filed May 18, 2023, the disclosures of which are hereby incorporated by reference in their entireties.

### GOVERNMENT LICENSE RIGHTS

This invention was made with United States government support under 1730147 and 2047341 awarded by the National Science Foundation. The U.S. government has certain rights in the invention.

### BACKGROUND

### 1. Field

This disclosure relates generally to interferometry and, in non-limiting embodiments, to a system and method for swept-angle interferometry.

### 2. Technical Considerations

Depth sensing is among core problems of computer vision and computational imaging, with widespread applications in medicine, industry, and robotics. An array of techniques is available for acquiring depth maps of three-dimensional (3D) scenes at different scales. In particular, micrometer-resolution depth sensing is important in biomedical imaging because biological features are often micron-scale, industrial fabrication and inspection of critical parts that must conform to their specifications, and robotics to handle fine objects. Active illumination depth sensing techniques such as lidar, structured light, and correlation time-of-flight (ToF) cannot provide micrometer axial resolution.

### SUMMARY

According to non-limiting embodiments or aspects, provided is a system for swept-angle interferometry comprising: a light source configured to emit at least one beam having at least two wavelengths; a beam steering device configured to steer the at least one beam across at least one axis of motion; a lens arranged in an optical path between the beam steering device and a target of the at least one beam, the lens having a focal plane; and a relay lens arranged in the optical path between the beam steering device and the lens.

In non-limiting embodiments or aspects, the system further comprises: a collimator arranged in the optical path between the light source and the beam steering device, the collimator configured to narrow the at least one beam. In non-limiting embodiments or aspects, the system further comprises: at least one computing device programmed or configured to: control the beam steering device to steer the at least one beam across two axes of motion through the relay lens. In non-limiting embodiments or aspects, steering the at least one beam across the two axes of motion through the relay lens comprises steering the at least one beam to be incident upon the relay lens at different angles such that the at least one beam is focused on different portions of the focal plane. In non-limiting embodiments or aspects, the system further comprises: a beam splitter arranged between the lens and the target, the beam splitter configured to: (i) split the at least one beam into a first plurality of beams and a second plurality of beams, (ii) direct the first plurality of beams to a reference mirror, (iii) direct the second plurality of beams to the target, and (iv) direct illumination reflected from the reference mirror and illumination reflected from the target to a sensor.

In non-limiting embodiments or aspects, the system further comprises: at least one computing device programmed or configured to: receive sensor data from the sensor, the sensor data representing the illumination reflected by the target and the illumination reflected by the reference mirror; and determine, based on the sensor data, a depth of at least one surface feature of the target. In non-limiting embodiments or aspects, the at least one beam comprises: a plurality of beams having different wavelengths comprising the at least two wavelengths, a beam having a continuum of wavelengths comprising the at least two wavelengths, or any combination thereof.

According to non-limiting embodiments or aspects, provided is a method for swept-angle interferometry comprising: controlling a light source to emit at least one beam having at least two wavelengths toward a target; controlling a beam steering device to steer the at least one beam across at least one axis of motion within a focal plane of a lens arranged in an optical path between the beam steering device and the target; and determining, with at least one processor, a depth of at least one surface feature of the target based on illumination reflected by the target from the at least one beam.

In non-limiting embodiments or aspects, the method further comprises arranging a relay lens in the optical path between the beam steering device and the lens. In non-limiting embodiments or aspects, controlling the beam steering device comprises steering the at least one beam across two axes of motion through the relay lens. In non-limiting embodiments or aspects, the at least one beam comprises: a plurality of beams having different wavelengths comprising the at least two wavelengths, a beam having a continuum of wavelengths comprising the at least two wavelengths, or any combination thereof. In non-limiting embodiments or aspects, the method further comprises arranging a collimator in the optical path between the light source and the beam steering device, the collimator configured to narrow the at least one beam. In non-limiting embodiments or aspects, the method further comprises arranging a beam splitter between the lens and the target, the beam splitter configured to: (i) split the at least one beam into a first plurality of beams and a second plurality of beams, (ii) direct the first plurality of beams to a reference mirror, (iii) direct the second plurality of beams to the target, and (iv) direct illumination reflected from the reference mirror and the illumination reflected from the target to a sensor.

In non-limiting embodiments or aspects, further comprising receiving sensor data from the sensor, the sensor data representing the illumination reflected by the target and the illumination reflected by the reference mirror, the depth of the at least one surface feature is determined based on the sensor data.

According to non-limiting embodiments or aspects, provided is a system for swept-angle interferometry comprising: a light source configured to emit at least one beam having at least two wavelengths toward a target; a beam steering device; and at least one processor configured to control the beam steering device to steer the at least one beam across at least two axes of motion through at least one lens arranged in an optical path between the light source and the target such that the at least one beam is incident upon the at least one lens at angles that differ during the motion.

In non-limiting embodiments or aspects, the system further comprises: at least one sensor configured to capture an illumination reflected by the target from the at least one beam, the at least one processor is configured to determine a depth of at least one surface feature of the target based on the illumination captured by the at least one sensor. In non-limiting embodiments or aspects, the at least one processor comprises a first processor configured to steer the beam steering device and a second processor configured to determine the depth of the at least one surface feature. In non-limiting embodiments or aspects, the system further comprises the at least one lens, the at least one lens comprising: a first lens arranged in an optical path between the beam steering device and the target of the at least one beam, the lens having a focal plane; and a relay lens arranged in the optical path between the beam steering device and the first lens, the at least one beam is incident upon the relay lens at angles that differ during the motion such that the at least one beam is focused on different portions of the focal plane of the first lens.

In non-limiting embodiments or aspects, the system further comprises: a collimator arranged in an optical path between the light source and the beam steering device, the collimator configured to narrow the at least one beam. In non-limiting embodiments or aspects, the system further comprises: a beam splitter arranged between the at least one lens and the target, the beam splitter configured to: (i) split a plurality of beams into a first plurality of beams and a second plurality of beams, (ii) direct the first plurality of beams to a reference mirror, (iii) direct the second plurality of beams to the target, and (iv) direct illumination reflected from the reference mirror and the illumination reflected from the target to at least one sensor.

Other non-limiting embodiments or aspects will be set forth in the following numbered clauses:

Clause 1: A system for swept-angle interferometry comprising: a light source configured to emit at least one beam having at least two wavelengths; a beam steering device configured to steer the at least one beam across at least one axis of motion; a lens arranged in an optical path between the beam steering device and a target of the at least one beam, the lens having a focal plane; and a relay lens arranged in the optical path between the beam steering device and the lens.

Clause 2: The system of clause 1, further comprising: a collimator arranged in the optical path between the light source and the beam steering device, the collimator configured to narrow the at least one beam.

Clause 3: The system of clause 1 or 2, further comprising: at least one computing device programmed or configured to: control the beam steering device to steer the at least one beam across two axes of motion through the relay lens.

Clause 4: The system of any of clauses 1-3, wherein steering the at least one beam across the two axes of motion through the relay lens comprises steering the at least one beam to be incident upon the relay lens at different angles such that the at least one beam is focused on different portions of the focal plane.

Clause 5: The system of any of clauses 1-4, further comprising: a beam splitter arranged between the lens and the target, the beam splitter configured to: (i) split the at least one beam into a first plurality of beams and a second plurality of beams, (ii) direct the first plurality of beams to a reference mirror, (iii) direct the second plurality of beams to the target, and (iv) direct illumination reflected from the reference mirror and illumination reflected from the target to a sensor.

Clause 6: The system of any of clauses 1-5, further comprising: at least one computing device programmed or configured to: receive sensor data from the sensor, the sensor data representing the illumination reflected by the target and the illumination reflected by the reference mirror; and determine, based on the sensor data, a depth of at least one surface feature of the target.

Clause 7: The system of any of clauses 1-6, wherein the at least one beam comprises: a plurality of beams having different wavelengths comprising the at least two wavelengths, a beam having a continuum of wavelengths comprising the at least two wavelengths, or any combination thereof.

Clause 8: A method for swept-angle interferometry comprising: controlling a light source to emit at least one beam having at least two wavelengths toward a target; controlling a beam steering device to steer the at least one beam across at least one axis of motion within a focal plane of a lens arranged in an optical path between the beam steering device and the target; and determining, with at least one processor, a depth of at least one surface feature of the target based on illumination reflected by the target from the at least one beam.

Clause 9: The method of clause 8, further comprising arranging a relay lens in the optical path between the beam steering device and the lens.

Clause 10: The method of clause 8 or 9, wherein controlling the beam steering device comprises steering the at least one beam across two axes of motion through the relay lens.

Clause 11: The method of any of clauses 8-10, wherein the at least one beam comprises: a plurality of beams having different wavelengths comprising the at least two wavelengths, a beam having a continuum of wavelengths comprising the at least two wavelengths, or any combination thereof.

Clause 12: The method of any of clauses 8-11, further comprising arranging a collimator in the optical path between the light source and the beam steering device, the collimator configured to narrow the at least one beam.

Clause 13: The method of any of clauses 8-12, further comprising arranging a beam splitter between the lens and the target, the beam splitter configured to: (i) split the at least one beam into a first plurality of beams and a second plurality of beams, (ii) direct the first plurality of beams to a reference mirror, (iii) direct the second plurality of beams to the target, and (iv) direct illumination reflected from the reference mirror and the illumination reflected from the target to a sensor.

Clause 14: The method of any of clauses 8-13, further comprising receiving sensor data from the sensor, the sensor data representing the illumination reflected by the target and the illumination reflected by the reference mirror, wherein the depth of the at least one surface feature is determined based on the sensor data.

Clause 15: A system for swept-angle interferometry comprising: a light source configured to emit at least one beam having at least two wavelengths toward a target; a beam steering device; and at least one processor configured to control the beam steering device to steer the at least one beam across at least two axes of motion through at least one lens arranged in an optical path between the light source and the target such that the at least one beam is incident upon the at least one lens at angles that differ during the motion.

Clause 16: The system of clause 15, further comprising: at least one sensor configured to capture an illumination reflected by the target from the at least one beam, wherein the at least one processor is configured to determine a depth of at least one surface feature of the target based on the illumination captured by the at least one sensor.

Clause 17: The system of clause 15 or 16, wherein the at least one processor comprises a first processor configured to steer the beam steering device and a second processor configured to determine the depth of the at least one surface feature.

Clause 18: The system of any of clauses 15-17, further comprising the at least one lens, the at least one lens comprising: a first lens arranged in an optical path between the beam steering device and the target of the at least one beam, the lens having a focal plane; and a relay lens arranged in the optical path between the beam steering device and the first lens, wherein the at least one beam is incident upon the relay lens at angles that differ during the motion such that the at least one beam is focused on different portions of the focal plane of the first lens.

Clause 19: The system of any of clauses 15-18, further comprising: a collimator arranged in an optical path between the light source and the beam steering device, the collimator configured to narrow the at least one beam.

Clause 20: The system of any of clauses 15-19, further comprising: a beam splitter arranged between the at least one lens and the target, the beam splitter configured to: (i) split a plurality of beams into a first plurality of beams and a second plurality of beams, (ii) direct the first plurality of beams to a reference mirror, (iii) direct the second plurality of beams to the target, and (iv) direct illumination reflected from the reference mirror and the illumination reflected from the target to at least one sensor.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic diagram of a system for swept-angle interferometry according to non-limiting embodiments;

FIG. 2 is a schematic diagram of an image processing pipeline in a system for swept-angle interferometry according to non-limiting embodiments;

FIG. 3 is a flow diagram of a method for swept-angle interferometry according to non-limiting embodiments; and

FIG. 4 illustrates example components of a computing device used in connection with non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

Non-limiting embodiments described herein provide for a new and innovative imaging system and method that may be referred to as swept-angle interferometry or swept-angle synthetic wavelength interferometry. Non-limiting embodiments provide for full-field, micron-scale 3D sensing. Non-limiting embodiments provide an unconventional light source that, by emulating spatially-incoherent illumination, results in interferometric measurements insensitive to global illumination. Non-limiting embodiments advantageously provide a faster, more efficient way to retrieve robust, detailed depth results that can recover full-frame depth at a spatial and axial resolution of a few micrometers using a limited number of measurements (e.g., 16 measurements in some examples), resulting in fast acquisition at frame rates of 1 Hz. It will be appreciated that various numbers of measurements and various different frame rates may be used in different embodiments and implementations. For example, non-limiting embodiments may produce detailed measurements from data captured at orders of magnitude faster, and while operating at strong ambient light, than a resource-intensive full-field optical coherence tomography system.

Non-limiting embodiments described herein utilize components of a Michelson interferometer in combination with a new and novel arrangement of devices and processes. In a Michelson interferometer, a beam splitter is used to divide collimated input illumination into two beams: one that propagates toward the scene arm, and another propagates toward the reference arm (e.g., such as a planar mirror mounted on a translation stage that can vary the mirror's distance from the beam splitter). After reflection, the two light beams recombine at the beam splitter and propagate toward the sensor. The variables l and d(x) represent the distance from the beam splitter of the reference mirror and the scene point that pixel x images, respectively. Since l is a controllable parameter, it may be denoted explicitly. The values of uᵣ(x, l) and uₛ(x) may represent complex fields arriving at sensor pixel x from the reference and scene arms, respectively. Then, the sensor measures I(x, l) as follows:

$$I ( x , l ) = {\underbrace{{‖ {u}_{s} ( x ) ‖}^{2} + {‖ {u}_{r} ( x , l ) ‖}^{2}}}_{≡ ℐ ( x , l )} + 2 Re \{ {\underbrace{{u}_{s} ( x ) {u}_{r}^{*} ( x , l )}}_{≡ 𝒞 ( x , l )} \} \qquad ( Equation 1 )$$

The first two terms in Equation 1 correspond to the intensities the sensor would measure if it were observing each of the two arms separately. The sum may be referred to as an interference-free image (I). The third term, called interference, relates to the complex correlation C between the reflected scene and reference fields.

Synthetic wavelength interferometry (SWI) uses illumination comprising two distinct, but narrowly-separated, wave-lengths that are incoherent with each other. These wavelengths may be denoted as λ and λ/_{1+ϵ}, corresponding to wavenumbers κ≡2π/λ and (1+ϵ)κ, respectively. This illumination is assumed to be injected into the interferometer as a collimated beam (e.g., in some examples, created by placing the outputs of two fiber-coupled single-frequency lasers at the focal plane of a lens). The correlation C(x,l) equals:

C(x,l)=exp(−2iκ(d(x)−l))[1+exp(−2iκϵ(d(x)−l))] (Equation 2)

The interference component of the camera intensity measurements in Equation 1 are as follows:

$$Re ( 𝒞 ( x , l ) ) = 2 sin ( κ ( 2 + ϵ ) ( d ( x ) - l ) ) sin ( κϵ ( d ( x ) - l ) ) \approx 2 sin ( 2 κ ( d ( x ) - l ) ) sin ( κϵ ( d ( x ) - l ) ) . \qquad ( Equations 3 and 4 )$$

The approximation is accurate when ϵ<<1, i.e., when the two wavelengths are close. As a function of d(x)−l, the interference is the product of two sinusoids: first, a carrier sinusoid with carrier wavelength λ_{c}≡λ/2 and corresponding carrier wavenumber κ_{c}≡2λ; second, an envelope sinusoid ϵ with synthetic wavelength λₛ≡λ/ϵ and corresponding synthetic wavenumber κₛ≡ϵκ:

ε(x,l)≡sin(κϵ(d(x)−l)). (Equation 5)

From Equation 5, it can be seen that SWI encodes scene depth d(x) in the phase φ(d(x))≡κϵ(d(x)−l) of the envelope sinusoid. SWI provides depth measurements at intervals of [0, λₛ], and may not disambiguate between depths differing by an integer multiple of λₛ. However, the use of two wavelengths makes it possible to control the unambiguous depth range because, by decreasing the separation ϵ between the two emitted wavelengths, the unambiguous depth range is increased at the cost of decreasing depth resolution.

Full-field interferometers use free-space optics (e.g., lenses, beam splitters, and/or the like) to illuminate and image the entire field of view in the scene and reference arms. Full-field interferometers also use a two-dimensional sensor to measure interference at all locations x. This enables fast interference measurements for all scene points at once and at lateral resolutions as high as the pixel pitch of the sensor. However, full-field interferometers are susceptible to phase corruption effects. Equation 5 assumes that the scene field is due to only the direct light path, which produces a sinusoidal envelope with phase delay d(x). In practice, the scene field will include contributions from additional paths. First, indirect paths due to subsurface scattering may contribute. Second, stray paths due to optical aberrations may contribute. These paths have different lengths, and thus contribute to the envelope sinusoidal terms of different phases. The summation of the paths produces an overall sinusoidal envelope with phase d′≠d(x), resulting in incorrect depth estimation.

Scanning interferometers use fiber optics (e.g., couplers, circulators, collimators, and/or the like) to generate a focused beam that illuminates only one point in the scene and reference arms. Additionally, scanning interferometers use a single-pixel sensor, focused at the same point. Scanning interferometers also use steering optics (e.g., micro-electro-mechanical systems (MEMS) mirrors) to scan the focus point and capture interference measurements for the entire scene. Scanning interferometers may effectively mitigate some phase corruption effects because, at any given time, they only illuminate and image one point in the scene. Such scanners eliminate contributions from indirect paths. Further, because the use of fiber optics minimizes aberrations, scanning interferometers may eliminate stray paths. This robustness comes at the cost of having to use beam steering to scan the entire scene, resulting in long acquisition times, especially when it is necessary to measure depth at pixel-level lateral resolutions and at a sensor-equivalent field of view.

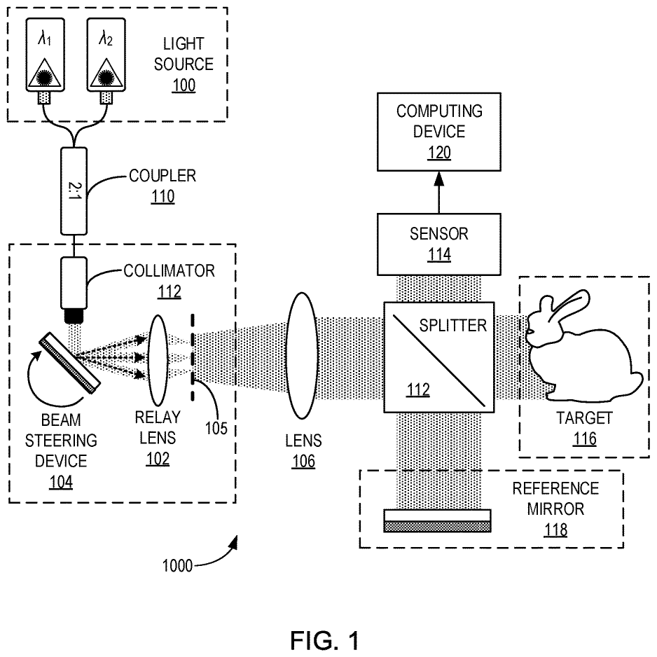

FIG. 1 depicts a system 1000 for swept-angle interferometry according to non-limiting embodiments or aspects. The system 1000 may be used for determining the depth of surface features of a target 116 (e.g., scene), such as one or more objects or portions thereof. The system 1000 includes a light source 100, which may be a plurality of lasers or any other light-emitting device capable of outputting at least one light beam having at least two wavelengths. The light source 100 may emit one or more beams of light having different wavelengths such that they can be differentiated. For example, the light source 100 may emit at least one beam having at least two wavelengths. In non-limiting embodiments, the emitted at least one beam may be a plurality of beams having different wavelengths. Additionally or alternatively, the emitted at least one beam may include a beam or multiple beams having a continuum of wavelengths along a spectrum.

With continued reference to FIG. 1, a coupler 110 is arranged in an optical path between the light source 100 and the target 116. A collimator 112 is arranged in the optical path between the coupler 110 and the target 116 and may narrow the plurality of beams into a collimated beam. For example, the outputs of two fiber-coupled single-frequency lasers may be placed at the focal plane of the lens 106. It will be appreciated that various arrangements may be used to direct at least one beam from the light source 100 to the beam steering device 104.

Extending an emission area of a light source (e.g., such as light source 100) also broadens its emission spectrum. This can make spatially-incoherent light sources incompatible with SWI that may rely on narrow-linewidth dichromatic illumination. In non-limiting embodiments, to address this issue, the light source 100 and beam steering device 104 are combined to result in an area emitter, as opposed to a point emitter, that changes the illumination from a single collimated beam parallel to the optical axis to the superposition of beams traveling along directions offset from the optical axis by angles θ∈[−Θ/2, Θ/2], where Θ depends on the emission area and lens focal length. The complex fields resulting from each such beam reflect on the target as uₛ^{θ}(x) and uₛ^{θ}(x, l). Because different points on the area emitter are incoherent with each other, the following equation can be applied:

$$I ( x , l ) = {\int }_{θ} {I}^{θ} ( x , l ) d θ , \qquad ( Equation 6 )$$

$$ℐ ( x , l ) = {\int }_{θ} {ℐ}^{θ} ( x , l ) d θ , 𝒞 ( x , l ) = {\int }_{θ} {𝒞}^{θ} ( x , l ) d θ ,$$

$${I}^{θ} ( x , l ) ≡ {\underbrace{{‖ {u}_{s}^{θ} ( x ) ‖}^{2} + {‖ {u}_{r}^{θ} ( x , l ) ‖}^{2}}}_{≡ {ℐ}^{θ} ( x , l )} + 2 Re \{ {\underbrace{{u}_{s}^{θ} ( x ) {u}_{r}^{θ *} ( x , l )}}_{≡ {𝒞}^{θ} ( x , l )} \}$$

In the above equation, the image I measured using an area emitter equals the sum of the images that would be measured using independent point emitters spanning the emission area, each producing illumination at an angle θ (and respectively for correlation). The system 1000 may be configured to emulate a spatially-incoherent source suitable for SWI through time-division multiplexing through the use of the beam steering device 104.

The system 1000 shown in FIG. 1 includes a beam steering device 104 configured to move along at least two axes. The beam steering device 104 may be moved by one or more motors controlled by one or more computing devices (not shown in FIG. 1). The beam steering device 104 may be arranged in the optical path between the collimator 112 and the target 116. In non-limiting embodiments, the beam steering device 104 may include a galvo mirror (e.g., mirror galvanometer) that steers a plurality of beams that are formed into a collimated beam of narrow-linewidth dichromatic illumination.

A relay lens 102 is arranged in the optical path between the beam steering device 104 and the target 116. Another lens 106 (e.g., an illumination lens) is arranged in the optical path between the relay lens 102 and the target 116. In operation, the beam steering device 104 may steer the light beams through different portions of the relay lens 102 such that the plurality of beams are incident upon the relay lens 102 at differing angles. For example, as the beam steering device 104 is controlled to move in a first axis and/or a second axis, the beams of light being reflected by the beam steering device move with respect to the stationary relay lens 102 and therefore the angles at which the beams hit the relay lens 102 also change. The lenses 102, 106 may be arranged such that the beams exiting the relay lens 102 are focused on a focal plane 105 of the lens and the beams are moved over an area of the focal plane 105. The beam steering device 104 may move the direction of the collimated beam and, as the beam moves, the focus point of the beam may scan an area on the focal plane 105 in x- and y-directions. By performing a full scan of the focus point over a target effective emission area within a single exposure, the acquired image and correlation measurements will align with the above equation. In this manner, the illumination angle is swept within the exposure.

In non-limiting embodiments, the system 1000 further includes a beam splitter 112 arranged in an optical path between the lens 106 and the target 116. The beam splitter 112 may be arranged to split the plurality of beams into a first plurality of beams and a second plurality of beams. The first plurality of beams may be directed by the beam splitter 112 to a reference mirror 118, which redirects the first plurality of beams to a sensor 114. The second plurality of beams may be directed by the beam splitter 112 to the target 116. The illumination reflected by the target 116 as a result of the second plurality of light beams may be further redirected by the beam splitter 112 to the sensor 114. In this manner, the sensor 114 receives the illumination reflected from the target 116 as a result of the first plurality of beams in addition to receiving the second plurality of beams from the reference mirror 118.

In non-limiting embodiments, the beam splitter may include a thin 50:50 plate beam splitter, which may reduce fringes as compared to pellicle and cube beam splitters. In non-limiting examples, the beam splitter 112 may be misaligned by design to avoid interreflections that would result in strong fringes. In non-limiting embodiments, the reference mirror 118 may be have a guaranteed λ/4 flatness to ensure a uniform phase reference throughout the field of view of the sensor 114. In non-limiting embodiments, the reference mirror 118 may be configured on a translation stage. For example, in some non-limiting embodiments, the translation stage may be a Newport ultra-precision motorized linear translation stage with a positioning accuracy of up to 10 nm and minimum incremental motion of 1 nm.

In non-limiting embodiments, the sensor 114 includes a camera and camera lens. Because the scenes are sized at the order of 1 inch in some non-limiting embodiments, using a camera lens that achieves high magnifications (e.g., a 1:1 reproduction ratio) provides for improved performance and allows for better contrast due to lower averaging of speckle (e.g., where the interference signal is convolved with the pixel box when captured with the camera). The camera lens may include, for example, a 180 mm Canon prime macro lens arranged in front of the camera. In non-limiting embodiments, the camera may be a machine vision camera (e.g., from Allied Vision, as an example) with a high-sensitivity CCD sensor of 8 MP resolution, and pixel size 3.5 μm. A sensor 114 with a small pixel pitch averages interference speckle over a smaller spatial area, therefore allowing for the system to resolve finer lateral detail. In non-limiting embodiments, a camera may be modified by removing the protective glass to avoid spurious interreflections caused by the protective glass.

With continued reference to FIG. 1, one or more computing devices 120 may receive the sensor data captured by the sensor 114 and process the sensor data from both the second plurality of light beams (e.g., illumination from reference light beams representative of the light beams before being reflected by the target 116) and the illumination resulting from the first plurality of light beams reflecting from the target 116. The computing device 120 may process the sensor data with one or more interferometric algorithms to determine a depth of one or more surface features of the target 116. As an example, the computing device 120 may generate a full or partial three-dimensional model of the target or a portion thereof.

In non-limiting embodiments, a nanometer-accuracy translation process (e.g., using a translation stage) may be implemented to vary the location/of the reference mirror 118. First, the envelope phase is estimated using an N-shift phase retrieval algorithm. It is assumed that estimates of the envelope (x, lₙ) are established at reference locations lₙ corresponding to shifts by N-th fractions of the synthetic wavelength λₛ, lₙ=l+nλs/N, n∈{0, . . . , N−1}. The envelope phase may be estimated as:

$$ϕ ( d ( x ) ) = arctan [ \frac{{\sum }_{n = 0}^{N - 1} ℰ ( x , {l}_{n} ) sin ( 2 π n / N )}{{\sum }_{n = 0}^{N - 1} ℰ ( x , {l}_{n} ) cos ( 2 π n / N )} ] , \qquad ( Equation 7 )$$

and the depth may be estimated (up to an integer multiple of λs) as:

d(x)=l+φ(d(x))/κ_{ϵ}. (Equation 8)

The above equation uses an estimate of the envelope s(x, lₙ) at each location lₙ. To estimate these values, for each lₙ, intensity measurements/(x, l^{m}?) are captured at M reference locations corresponding to shifts by M-th fractions of the carrier wavelength, l^{m}=lₙ+mλ_{c}/M, m∈{0, . . . , M−1}. As the carrier wavelength λ_{c} is half the optical wavelength λ and orders of magnitude smaller than the synthetic wavelength λₛ, the envelope and interference-free image remain approximately constant across these shifts, ε (x, l^{m})≈ε (x, lₙ), l (x, l^{m})≈l (x, lₙ). Then the following can be calculated:

$$I ( x , {l}_{n}^{m} ) = ℐ ( x , {l}_{n} ) + 2 sin ( {κ}_{c} ( d ( x ) - {I}_{n}^{m} ) ) ℰ ( x , {I}_{n} ) . \qquad ( Equation 9 )$$

The interference-free image (l(x, lₙ)) and envelope (ε(x, lₙ)) may then be estimated as:

$$ℐ ( x , {l}_{n} ) = 1 / M {\sum }_{m = 0}^{M - 1} ℐ ( x , {l}_{n}^{m} ) , \qquad ( Equations 10 , 11 )$$

$$\vert ℰ ( x , {l}_{n} ) \vert = \sqrt{1 / 2 M {\sum }_{m = 0}^{M - 1} {( ℐ ( x , {l}_{n}^{m} ) - ℐ ( x , {l}_{n} ) )}^{2}} .$$

The above Equation 11 for determining the envelope ε(x, lₙ) may estimate the envelope only up to sign, although it will be appreciated that other variations are possible in non-limiting embodiments.

It will be appreciated that various arrangements and components of the system 1000 shown in FIG. 1 may be used in non-limiting embodiments. In an example configuration, the light source 100 may include two distributed Bragg-reflector lasers (having wavelengths 780 nm and 781 nm, power 45 mW, linewidth 1 MHz). The lenses 102, 106 may be two compound macro lenses (having a focal length of 200 mm). The sensor 114 may be a charge-coupled device (CCD) sensor (having a pixel pitch of 3.7 μm and a resolution of 3400×2700 pixels. In an example, non-limiting configuration, the reproduction ratio may be 1:1, the field of view may be 12.5 mm×10 mm, and the working distance may be 400 mm. The unambiguous depth range may be approximately 500 μm. A minimum per-image exposure time may be 10 ms, resulting at a frame rate of 5 Hz. These values are for one possible configuration, but various values may be used in different configurations and implementations.

In non-limiting embodiments, the beam steering device 104 may include two fast-rotating mirrors to scan the laser beam in a 1°×1° angular pattern at slightly separated kHz frequencies. A relay lens 102 (e.g., a 35 mm Nikon prime lens in non-limiting examples) then maps beam orientation to spatial coordinates behind the illumination lens 106, creating the light source for swept-angle illumination. The created light source is a dense Lissajous curve that approximates a square.

In non-limiting embodiments, the illumination lens 106 may include a 200 mm Nikon prime lens. The illumination lens 106 may be a photographic lens, which may perform superior to AR-coated achromatic doublets in terms of spherical and chromatic aberration, therefore resulting in significantly lesser distortion in the generated wavefront.

In non-limiting embodiments, near-infrared single frequency tunable laser diodes may be used as the light source 100. Such laser diodes may be tunable in wavelength by adjusting either operating current or temperature of the diode. To create small wavelength separations (e.g., of the order of 0.01 nm), the operating current of one laser diode may be modulated with a square waveform, thus creating two time-multiplexed wavelengths. To create larger separations (e.g., of the order of 1 nm), two different laser diodes may be used that are selected at the appropriate central wavelengths. To increase the accuracy of depth recovery, the light source 100 may be monochromatic (single longitudinal mode), stable in wavelength and power, and accurately tunable. In non-limiting embodiments, the synthetic wavelength resulting from this illumination is sensitive to the separation between the two wavelengths, especially at microscopic scales. Therefore, after selecting a pair of lasers or current levels for an approximate synthetic wavelength, the actual synthetic wavelength may be estimated by measuring the envelope sinusoid for a planar diffuser scene at a dense collection of reference arm positions and then fitting a sinusoid to these measured magnitudes and using the fit wavelength as the synthetic wavelength.

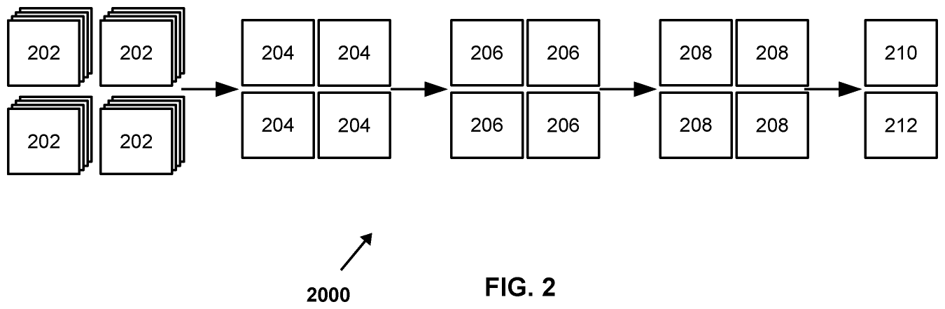

Referring now to FIG. 2, a phase estimation pipeline 2000 is shown according to non-limiting embodiments. The phase estimation pipeline 2000 may represent an algorithm that can be referred to as an {M, N}-shift phase algorithm, where the parameters M and N are design parameters that can be fine-tuned and/or adjusted to affect countering results of acquisition time and depth accuracy (e.g., adjusting the trade-off between speed and accuracy). The example shown in FIG. 2 is a {4, 4}-shift phase algorithm, where the values of M and N are both 4. As the values of M and N are increased, the number M*N of total images to capture also increases. At the same time, the final depth estimate becomes more robust to noise. The calculable minimum number of images may be achieved using {3, 3}shifts, corresponding to 9 images. In non-limiting embodiments, different shifts may be used. For example, performing {4, 4}shifts, corresponding to 16 images, as shown in the example phase estimation pipeline 200 may provide a robust performance across a variety of target objects (e.g., scenes).

With continued reference to FIG. 2, input images 202 may represent 16 reference positions in a {4, 4}-shift phase configuration, where the reference positions correspond to 4 synthetic by 4 carrier subwavelength shifts. At a next stage in the pipeline 200, an interference-free image 204 may be estimated for each synthetic subwavelength shift. At the next stage, an envelope image 206 may be estimated for each synthetic subwavelength shift. At the next stage of the pipeline 200, each envelope image 206 may be denoised using, for example, joint bilateral filtering, resulting in denoised envelope images 208. At a final stage, a 4-shift phase retrieval is used to estimate the envelope phase 210 and depth 212.

In non-limiting embodiments, interference in non-specular scenes may be in the form of speckle, a high-frequency pseudo-random pattern. This may be shown in input images (e.g., images 202 from FIG. 2). Speckle may result in a noisy envelope, which results in noise and inaccuracy in phase and depth estimates (e.g., 210, 212). The use of swept-angle illumination, as discussed with respect to FIG. 1, mitigates the effects of speckle. Speckle may be further reduced by denoising the estimated quantities with a low-pass filter (e.g., Gaussian). Additionally or alternatively, bilateral filtering with a guide image of the scanned scene captured under ambient light may be used to avoid blurring image details. In non-limiting embodiments, the envelope estimates are blurred before being processed to determine the final phase and depth estimates, which results in improved results compared to blurring the final phase and depth estimates.

In non-limiting embodiments, the optical set-up of the system 1000 can be aligned to optimize the depth estimation accuracy. For example, the light source 100, collimator 112, beam steering device 104, and/or relay lens 102 may be arranged on one or more rigid cage systems. The mirrors of the beam may be tuned electronically by adjusting their driving waveform's direct current (DC) offset, ensuring a mean direction of light propagation that is parallel to the optical axis of the interferometer.

In non-limiting embodiments, one or more software functions may be executed to reconstruct depth from {4, 4}-shift swept-angle synthetic wavelength interferometry frames. First, interference-free images may be obtained at each four-bucket position by averaging images captured with sub-wavelength shifts. Next, interference images at each four-bucket position may be obtained by subtracting interference-free images from the full images. Next, the absolute values of the envelope may be estimated by squaring and adding interference images. The estimated envelope may be filtered with bilateral filtering using an ambient light image of the scene as the guide image. The four-bucket phase retrieval algorithm may then be applied to estimate phase, which may be converted to depth.

In non-limiting embodiments, the following algorithm may be used for acquisition using a {M, N}-shift phase retrieval algorithm:

(Algorithm 1)

| Data: synthetic wavelength λₛ; optical wavelength | |
|---|---|
| λₒ; start position l | |
| $Result : intensity images ℐ ( x , {l}_{n}^{m} ) at reference$ | |
| $position {l}_{n}^{m} ( defined below )$ | |
| ${l}_{n}^{m} = l + n {λ}_{s} / N + m {λ}_{c} / M for$ | |
| n ∈ {0, ... , N − 1} and m ∈ {0, ... , M − 1}; | |
| /* Capture the intensity images in | |
| Figure 6 (a) | */ |

for bucket positions n ∈ {0, ... , N − 1} do
| for sub-wavelength shifts m ∈ {0 ... , M − 1}
| do
| | $move reference mirror to position {l}_{n}^{m} ;$
| | $capture image I ( x , {l}_{n}^{m} ) ;$
| end
end
$return I ( x , {l}_{n}^{m} )$

In non-limiting embodiments, the following algorithm may be used for reconstruction using a {M, N}-shift phase retrieval algorithm:

(Algorithm 2)

| Data: synthetic wavelength λₛ; optical wavelength | |
|---|---|
| λ_{c}; start position l; bilateral filter | |
| hyperparameters: spatial kernel size σₛ, and | |
| intensity kernel size σᵢ; intensity | |
| $measurements I ( x , {l}_{n}^{m} ) at reference position$ | |
| ${l}_{n}^{m} ( defined below ) ; scene ambient - light$ | |
| image S(x) | |
| Result: depth map d(x) | |
| /* Initialization | */ |
| Iₘₙ = l + nλₛ/N + mλ_{c}/M for n ∈ {0, ... , N} | |
| for m ∈ {0, ... , M}; | |
| for bucket positions n ∈ {0, ... , M} do | |
| \| /* Figure 6 (b) | */ |
| \| estimate interference-free image | |
| \| $ℐ ( x , {l}_{n} ) = ( {\sum }_{m = 0}^{M - 1} I ( x , {l}_{n}^{m} ) ) / M ;$ | |
| \| /* Figure 6 (c) | */ |
| \| estimate real parts of correlations | |
| \| $Re \{ 𝒞 ( x , {l}_{n}^{m} ) \} = I ( x , {l}_{n}^{m} ) - ℐ ( x , {l}_{n} ) ;$ | |
| \| estimate noisy envelope | |
| \| ${ℰ}^{2} ( x , {l}_{n} ) = {\sum }_{m = 0}^{M - 1} {( Re \{ 𝒞 ( x , {l}_{n}^{m} ) \} )}^{2} / 2 M ;$ | |
| \| /* Figure 6 (d) | */ |
| \| denoise envelope using the bilateral filter | |
| \| ${ℰ}_{bf}^{2} ( x , {l}_{n} ) = BilateralFilter ( {ℰ}^{2} ( x , {l}_{n} ) , S ( x ) , {σ}_{s} , {σ}_{i} ) ;$ | |
| end | |
| /* Figure 6 (e) | */ |

$estimate d ( x ) = \frac{1}{\text{?}} arc tan [ \frac{\text{?} - \text{?}}{\text{?} - \text{?}} ] + l ;$
return d(x)
$\text{?} \text{indicates text missing or illegible when filed}$

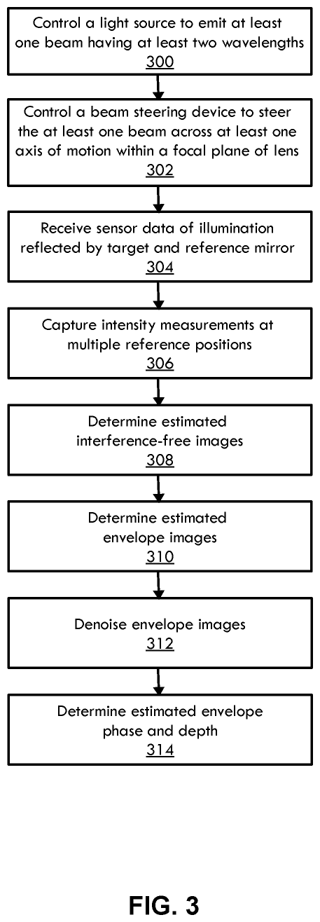

Referring now to FIG. 3, a method for swept-angle interferometry is shown according to non-limiting embodiments or aspects. It will be appreciated that the order of the steps shown in FIG. 3 is for illustrative purposes only and that non-limiting embodiments may involve more steps, fewer steps, different steps, and/or a different order of steps. At a first step 300, a light source is controlled to emit at least one beam having at least two wavelengths. For example, a plurality of lasers may be emitted where each laser has a different wavelength. In other examples, one or more laser beams may be emitted that output a continuum of wavelengths along a spectrum.

At step 302, a beam steering device may be controlled to steer the at least one beam across two axes of motion within a focal plane of a lens (e.g., an illumination lens in the optical path of the light beams). In non-limiting embodiments, the beam steering device may include a mirror galvanometer controlled with a computing device. In non-limiting embodiments, the beam steering device may move the at least one beam through a relay lens arranged in the optical path such that the beam is incident upon the relay lens at different angles. For example, with a stationary relay lens and a moving light beam, the angle that the beam hits the relay lens will change as the position of the beam moves across the relay lens.

At step 304, a computing device may receive sensor data from a sensor arranged to receive illumination reflected by the target (e.g., illumination from the light beams reflecting off of the target) and a reference mirror that reflects one or more split beams (e.g., reference light beams). The computing device may then execute a phase retrieval pipeline (e.g., phase retrieval algorithm) at steps 306-314 based on the sensor data. For example, at step 306, intensity measurements may be captured for multiple reference positions. For example, for M synthetic subwavelength shifts and N carrier subwavelength shifts, intensity measurements may be taken at M*N positions. At steps 308 and 310, estimated interference-free images and estimated envelope images are determined. The interference-free images may be determined using Equation 10 and the envelope images may be determined using Equation 11. However, it will be appreciated that variations of the example equations may be used to estimate the images.

At step 312 of FIG. 3, the envelope images may be denoised. In some non-limiting embodiments, denoising may be performed using joint bilateral filtering, although it will be appreciated that other denoising techniques may be used. At step 314, the estimated envelope phase may be determined using Equation 7 and the estimated depth may be determined using Equation 8. It will be appreciated that variations of the example equations may be used to estimate the phase and depth.

In non-limiting embodiments, because depth may be computed from phase, such determinations may only determine depth up to an integer multiple of the synthetic wavelength λₛ. Thus, all depths in the scene may be wrapped to [0, λs], even if the depth range is greater. To mitigate phase wrapping and extend the unambiguous depth range, phase unwrapping algorithms may be used in connection with the systems and methods described herein. Such phase unwrapping may include capturing measurements at multiple synthetic wavelengths, and using the captured measurements to unwrap the phase estimate.

In experiments using non-limiting embodiments, the use of swept-angle illumination greatly improved reconstruction quality. Improvements were realized in scenes with strong subsurface scattering as well as in metallic scenes where there is no subsurface scattering. Moreover, experiments showed that non-limiting embodiments described herein can proximate the reconstruction quality of optical coherence tomography (OCT) while being up to 50× faster. In non-limiting embodiments, by adjusting the wavelength separation between the two lasers used as the light source, macroscopic scenes can be scanned with a depth range of 16 mm art a resolution of 50 μm, at a significantly better quality than existing full-field techniques. Moreover, experiments show that non-limiting embodiments are robust to strong ambient lighting through the use of near-monochromatic illumination, even where the ambient lighting presents 10% signal-to-background ratios. Further, non-limiting embodiments may be adjusted per implementation and/or in an ad hoc manner by adjusting the values of M and N parameters, thereby adjusting acquisition time and reconstruction quality.

In non-limiting embodiments, a stronger laser may be used to reduce the exposure time per image. A faster translation stage (e.g., fast microscopy stage) may be used to more efficiently process the phase shifts from translating the reference mirror. In some non-limiting embodiments, the processing bottleneck from using reduced exposer times and stronger lasers may be addressed with phase modulators and multiple mirrors configured to perform the phase shifts without mechanical motion.

Non-limiting embodiments for scenes with low reflectivity may perform depth sensing at 1 Hz. In the equivalent time of 1 s, the scanner performs 16 passes over the scene to take the 16 measurements required for the {4, 4}-shift algorithm. This makes the maximum number of points that the scanner can measure in two dimensions 30,000/16=1875. In one dimension, this translates to the square root of 1875, about 43 points. The captured images may have the approximate dimension of 1600×1300. Distributing these points equally along the larger dimension yields a downsampling factor of 1600/43≈35. This calculation is beneficial for two reasons. First, the typical scan rate will be lower than the nominal scan rate of 30 kHz because of the need to scan a larger field of view and/or the inability to drive both axes at resonant mode. Second, for scenes with high reflectivity (e.g., metallic scenes), some non-limiting embodiments may operate at 10 Hz, and thus the number of scanned points should be 10× fewer.

In non-limiting embodiments, a laser beam that can be collimated or focused at a few micrometers may be used to achieve micrometer lateral resolutions. As an alternative to using thin, collimated laser beams, some non-limiting implementations may use a beam that is focused at each point on the scene. However, focusing the laser beam onto the scanned scene points and sharply decreases the depth of field of the imaging system. Thus, such implementations may utilize another axial scan to ensure that the scanned post is within the depth of field, which adds to acquisition time.

In non-limiting embodiments, SWI does not need to include the performance of lateral scanning. Instead, it accomplishes direct-only (e.g., coaxial) imaging by scanning an area in the focal plane of the collimating lens, an operation that can be done in the resonant mode of a MEMS mirror within exposure.

In non-limiting embodiments, using higher values of M and N in an {M, N}-shift algorithm allows for a reduction in the per-image acquisition time by requiring a lower scanned source density for equal visual depth quality. For example, a 100 ms scan with the {4, 5}-shift algorithm performs as well as a 10 ms scan with a {5, 5}-shift algorithm, reducing the total acquisition time from 2 s to 250 ms.

In non-limiting embodiments, the depth range may be tuned based on the current used in an implementation. The use of two wavelengths in synthetic wavelength interferometry makes it possible to control the unambiguous depth range: By decreasing the separation KE between the two laser wavelengths, the unambiguous depth range is increased at the cost of decreasing depth resolution. In particular, picometer separations in wavelengths result in synthetic wavelengths of centimeters. By mitigating the effects of the significant subsurface scattering present in all scenes, the use of swept-angle illumination greatly improves reconstruction quality. Achieving picometer-scale wavelength separation may be achieved using current-based tuning of the wavelength of distributed Bragg reflector laser (DBR) lasers having a linear response of wavelength to current near their operating point. The current may be tuned by, for example, 50 mA to provide picometer-scale wavelength separations.

In non-limiting embodiments, ambient light that may degrade a depth calculation may be rejected by using an ultra-narrow spectral filter centered at the average illumination wavelength.

Non-limiting embodiments described herein may be used for medical OCT imaging, surface detection, and/or any other application in which interferometry can be used to sense features of an object, scene, person, or the like.

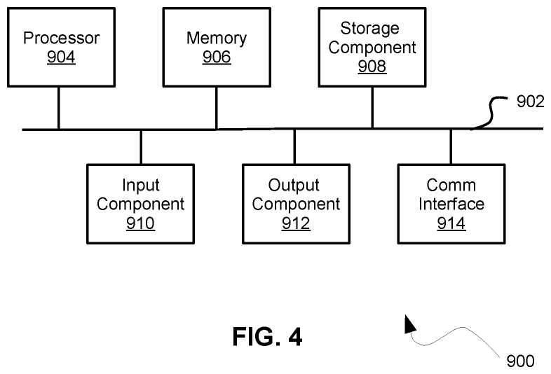

Referring now to FIG. 4, shown is a diagram of example components of a computing device 900 for implementing and performing the systems and methods described herein according to non-limiting embodiments, such as but not limited to computing device 120 shown in FIG. 1. In some non-limiting embodiments, device 900 may include additional components, fewer components, different components, or differently arranged components than those shown in FIG. 4. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 4, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a photo-sensor, a thermal sensor, an electromagnetic field sensor, a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for swept-angle interferometry comprising:
a light source configured to emit at least one beam having at least two wavelengths;
a beam steering device configured to steer the at least one beam across at least one axis of motion;
a lens arranged in an optical path between the beam steering device and a target of the at least one beam, the lens having a focal plane; and
a relay lens arranged in the optical path between the beam steering device and the lens.

2. The system of claim 1, further comprising:
a collimator arranged in the optical path between the light source and the beam steering device, the collimator configured to narrow the at least one beam.

3. The system of claim 1, further comprising:
at least one computing device programmed or configured to:
control the beam steering device to steer the at least one beam across two axes of motion through the relay lens.

4. The system of claim 3, wherein steering the at least one beam across the two axes of motion through the relay lens comprises steering the at least one beam to be incident upon the relay lens at different angles such that the at least one beam is focused on different portions of the focal plane.

5. The system of claim 1, further comprising:
a beam splitter arranged between the lens and the target, the beam splitter configured to: (i) split the at least one beam into a first plurality of beams and a second plurality of beams, (ii) direct the first plurality of beams to a reference mirror, (iii) direct the second plurality of beams to the target, and (iv) direct illumination reflected from the reference mirror and illumination reflected from the target to a sensor.

6. The system of claim 5, further comprising:
at least one computing device programmed or configured to:
receive sensor data from the sensor, the sensor data representing the illumination reflected by the target and the illumination reflected by the reference mirror; and
determine, based on the sensor data, a depth of at least one surface feature of the target.

7. The system of claim 1, wherein the at least one beam comprises: a plurality of beams having different wavelengths comprising the at least two wavelengths, a beam having a continuum of wavelengths comprising the at least two wavelengths, or any combination thereof.

8. A method for swept-angle interferometry comprising:
controlling a light source to emit at least one beam having at least two wavelengths toward a target;
controlling a beam steering device to steer the at least one beam across at least one axis of motion within a focal plane of a lens arranged in an optical path between the beam steering device and the target; and
determining, with at least one processor, a depth of at least one surface feature of the target based on illumination reflected by the target from the at least one beam.

9. The method of claim 8, further comprising arranging a relay lens in the optical path between the beam steering device and the lens.

10. The method of claim 9, wherein controlling the beam steering device comprises steering the at least one beam across two axes of motion through the relay lens.

11. The method of claim 8, wherein the at least one beam comprises: a plurality of beams having different wavelengths comprising the at least two wavelengths, a beam having a continuum of wavelengths comprising the at least two wavelengths, or any combination thereof.

12. The method of claim 8, further comprising arranging a collimator in the optical path between the light source and the beam steering device, the collimator configured to narrow the at least one beam.

13. The method of claim 8, further comprising arranging a beam splitter between the lens and the target, the beam splitter configured to: (i) split the at least one beam into a first plurality of beams and a second plurality of beams, (ii) direct the first plurality of beams to a reference mirror, (iii) direct the second plurality of beams to the target, and (iv) direct illumination reflected from the reference mirror and the illumination reflected from the target to a sensor.

14. The method of claim 13, further comprising receiving sensor data from the sensor, the sensor data representing the illumination reflected by the target and the illumination reflected by the reference mirror, wherein the depth of the at least one surface feature is determined based on the sensor data.

15. A system for swept-angle interferometry comprising:
a light source configured to emit at least one beam having at least two wavelengths toward a target;
a beam steering device; and
at least one processor configured to control the beam steering device to steer the at least one beam across at least two axes of motion through at least one lens arranged in an optical path between the light source and the target such that the at least one beam is incident upon the at least one lens at angles that differ during the motion.

16. The system of claim 15, further comprising:
at least one sensor configured to capture an illumination reflected by the target from the at least one beam, wherein the at least one processor is configured to determine a depth of at least one surface feature of the target based on the illumination captured by the at least one sensor.

17. The system of claim 16, wherein the at least one processor comprises a first processor configured to steer the beam steering device and a second processor configured to determine the depth of the at least one surface feature.

18. The system of claim 15, further comprising the at least one lens, the at least one lens comprising:
a first lens arranged in an optical path between the beam steering device and the target of the at least one beam, the lens having a focal plane; and
a relay lens arranged in the optical path between the beam steering device and the first lens, wherein the at least one beam is incident upon the relay lens at angles that differ during the motion such that the at least one beam is focused on different portions of the focal plane of the first lens.

19. The system of claim 15, further comprising:
a collimator arranged in an optical path between the light source and the beam steering device, the collimator configured to narrow the at least one beam.

20. The system of claim 15, further comprising:
a beam splitter arranged between the at least one lens and the target, the beam splitter configured to: (i) split a plurality of beams into a first plurality of beams and a second plurality of beams, (ii) direct the first plurality of beams to a reference mirror, (iii) direct the second plurality of beams to the target, and (iv) direct illumination reflected from the reference mirror and the illumination reflected from the target to at least one sensor.
